(19) United States
(12) Patent Application Publication
(10) Pub. No.: US 2005/0283314 A1
(43) Pub. Date: Dec. 22, 2005

(54) Apparatus, method and system of information gathering and use

(75) Inventor: Tom E. Hall, Clive, IA (US)

Correspondence Address: MCKEE, VOORHEES & SEASE, P.L.C.;ATTN: PIONEER HI-BRED, 801 GRAND AVENUE, SUITE 3200, DES MOINES, IA, 50309-2721, US

(73) Assignee: Pioneer Hi-Bred International, Inc., Johnston, IA (US)

(21) Appl. No.: 11/150,455

(22) Filed: Jun. 10, 2005

Related U.S. Application Data
(60) Provisional application No. 60/579,120, filed on Jun. 10, 2004.

(51) Int. Cl. G06F 19/00

(52) U.S. Cl. 702/2

(57) ABSTRACT

An apparatus, method, and system for efficient data collection of field service calls and the like, and subsequent use of that data. One example of a method according to the invention comprises entering data in a portable digital device based on a systematic template which is pre-designed to limit subjectivity and promote consistency of data collection. An apparatus according to the invention includes a portable digital device that allows display of standardized templates that cue the field service agronomist with regard to the information and content to collect and store in the portable digital device. One example of a system according to the present invention includes a plurality of portable digital devices used by a plurality of field service agronomists to collect field service calls at different times, locations, and situations, and a communication medium or network to communicate at least some of the collected data to a database. The database can be used to store collected data and can be accessed and mined for information that can be used in many phases of agribusiness, including but not limited to marketing and sales of agricultural products, research and development for future agricultural products, and analysis and solutions to agricultural problems.

### CROSS-REFERENCE TO RELATED APPLICATION

This application claims priority to U.S. Provisional Patent Application Ser. No. 60/579,120 filed Jun. 10, 2004 which is incorporated by reference herein in its entirety.

### INCORPORATION BY REFERENCE

The contents of co-pending U.S. patent application Ser. No. (not yet assigned) entitled “Method for Use of Environmental Classification”, filed Jun. 10, 2005, Attorney Docket No. P07244US00, is incorporated by reference herein in its entirety.

### I. BACKGROUND OF THE INVENTION

A. Field of the Invention

The present invention relates to information gathering and use, and in particular, utilizing digital data devices to present pre-designed templates to the user for the information gathering and software to allow storage, manipulation, and display of selected information.

In one exemplary application of the invention, the information gathering relates to field service calls by a Field Service Agronomist (FSA).

B. Problems in the Art

Many industries produce a product which must be marketed, sold, and supplied to customers or end-users. For example, in agriculture, a variety of companies research, develop, and produce crop seed. Presently, substantial resources are devoted to advanced research to develop seed having traits which perform better under circumstances. Some seed is more resistant to drier soil conditions. Some seed is resistant to certain pests or diseases. Some seed produces harvested crop with certain desirable characteristics. These are but a few examples.

Traditionally, such seed is sold by marketing or sales representatives either directly to farmers or to distributors. Substantial resources must be devoted to making the sales and marketing processes as profitable as possible.

Another aspect of the seed industry involves the accurate and timely supply of seed that has been purchased. This is not a trivial matter. The variety of seed of different characteristics requires careful coordination of its growing and producing an inventory to meet end user demand.

As can be appreciated, however, good business practices dictate that a substantial service component also be provided by seed companies to their distributors and end users. Customer service can impact all phases of a seed company's business. With regard to sales and marketing, customer relationships are important. Thus, resources are usually devoted to fostering and maintaining good customer relationships. Customer service also usually involves expending resources with respect to trying to make sure the supply chain is working smoothly. Sometimes there must be remedial action taken to serve the customer.

The service component of business is not only temporal in the sense there is a need to maintain present good customer relations. Ideally it also looks both backwards and forwards in time. For example, customer service can involve storing information about past research, sales, marketing, supply, and performance to help shape future action. It can look forward in many ways also. For example, using present information obtained through customer service representations, one can analyze and even sometimes predict customer needs or potential problems. Preventive measurements, before the fact, can be implemented.

In the example of seed companies, one significant aspect of customer service practice is to send an FSA to a farmer. This could be the result of either the farmer calling for service or the seed company calling upon the farmer. A specific example might be as follows. A farmer has planted corn seed from a seed company. Part way through the growing season, the farmer notices some of the corn is not growing well. The farmer calls the seed company to report the problem. The seed company sends a customer service representative, the FSA, to the location of the farmer. The FSA personally inspects the field with the problem plants. The FSA returns to the company to report what was observed. The FSA might write down handwritten notes regarding the call. Personnel at the company than collaborate and decide what assistance, if any, might be given to the farmer.

While such a system has been utilized for years, it is believed there is room for improvement. Such an information gathering system relies heavily on the perception, memory, diligence, and training of the customer service representative. Important information could be forgotten or missed. Notes taken by an individual may not be understandable or accurately interpreted by other people. Therefore, the accuracy and dependability of such a system has some weaknesses. It could result in customer dissatisfaction or incorrect attempts at remedying a problem. The problem is magnified because one seed company, for example, could see and diagnose potential crop problems in hundreds of fields each year, and there may be hundreds of FSAs making the field service calls and crop observations.

It is believed that some FSAs have tried to develop aids to recording information about field calls. Some utilize ad hoc forms, the intent being the FSA would have a form to record notes, observations, and comments. However, no such form is known which is relatively consistent across all seed types or variations within a type, is systematic in its design, and tries to limit the amount of subjectivity or perceptual bias that can creep into a less systematic information gathering process.

Ad hoc, form-based approaches can be somewhat helpful. They can help the representative reconstruct at least some things regarding a service call. However, they may not be very helpful as to things deemed relevant after the call. Such forms still require hand-written notations and are also not particularly helpful for long term storage and retrieving of information or for evaluation of the information on a broader scale (e.g., for a region as opposed to individual farmer by farmer). At best, present systems, including those that use ad hoc forms, may enhance the traditional field service call information gathering task of a FSA. However, it still relies heavily on FSA skill and training. Even with ad hoc forms, information goes missing, the notations of the particular FSA can be misinterpreted by others, and it most times continues to allow too much subjectivity based on FSA perceptions into the information recordation.

Therefore, there is a need in the art for a better information gathering and capturing system for seed companies and related agriculture uses. The need also exists for analogous data gathering functions.

With respect to seed companies, improved data gathering for service calls can advantageously affect sales and marketing. It can improve customer satisfaction. It can assist in diagnosis or discovery of needs or problems of customers.

With respect to research and development, it can assist the company in developing improved products and in positioning those products through the use of environmental classification efforts. Environmental classification efforts assist in plant selection. The performance or phenotype results from an interaction between the plant's genotype and the environment. An environment at a given location changes over the years making multi-environment trials (METs) performed in the same location limited as to inferences about future crop performance. Furthermore, inferences about a crop's future performance in different locations depend on whether the target population of environments (TPEs) are well sampled since the environment varies between different locations in one year. Therefore, the interaction of genotype with environment, referred to herein as G×E, is of primary importance in the research of major crops grown in a wide range of environments. G×E refers to a phenomenon where different environments may have different effects on different genotypes. Thus, analyzing G×E interactions provides information about the effect of different environments on hybrid performance. Environmental classification is a method of describing G×E interaction where environments are classified into one of a plurality of different environmental classifications based on environmental and physiological landmark. Such data may be historical data such as historical meteorological information along with soils and other agronomic information or collected using National Oceanic and Atmospheric Association and/or other public sources of weather and soil data. Potential environmental and physiological landmark data that may be collected includes but is not limited to wind, temperature, solar radiation, precipitation, soil type, soil pH, planting and harvesting dates, irrigation, tiled area, previous crop, fertilizer including nitrogen, phosphorous, and potassium levels, insecticide, herbicide, and biotic data, for example, insects and disease.

One of the problems with use of G×E interactions is the lack of data available to perform meaningful analysis. The G×E information has application in planning and positioning, i.e. selecting products for land bases belonging to specific environmental classes, and crop modeling. What is needed is methods and systems for collection of data such as from Field Service Agents in a consistent and useable manner in order to assist in environmental classification efforts.

With respect to supply management, improved data gathering for service calls can improve customer satisfaction and identify supply chain issues or problems.

Additionally, an improved data gathering and capture system can be important with respect to ancillary needs of the company. For example, more systematic and objective documentation of events relevant to a seed company's activities is desirable and can be important with respect to legal issues. A better data gathering and documentation system could assist in defending against a variety of legal challenges. Analogous benefits can assist other companies or businesses.

### II. SUMMARY OF THE INVENTION

It is therefore a principle object, feature, advantage, or aspect of the present invention to provide an apparatus, method, and system for information gathering and use which improves over or solves problems and deficiencies in the art.

Further objects, features, advantages, or aspects of the present invention are to provide an apparatus, method, and system as above described which:
a) improves the capturing of field or customer service calls with regard to information as well as observations.
b) allows integration of geographical references or other customer specific data with service call information and observations.
c) allows sharing and exchange of information between representatives and the company, or the company and its customers.
d) allows a variety of uses of the captured information.
e) allows storage or archiving of data, including geographic or other customer specific references.
f) promotes standardization of data capture, and further promotes capturing of facts as opposed to subjective observations.
g) is relatively easy to use.
h) is practical, efficient, and relatively economical.
i) is flexible and customizable, and can be used in a variety of applications.
j) allows communication of captured data with a variety of devices, networks, and data bases.
k) allows use with a web site where authorized users can have access to information.
l) allows integration of captured data with other information to display or prepare reports that can transform the captured data into valuable, usable derivative information or analysis.
m) allows use of either individual data from individual customers or merged information from a variety of customers.
n) can be used by a variety of interested entities, including but not limited to a company and/or its customers.
o) can be updated in essentially real time.
p) can have a variety of user interfaces, reports, and displays according to desired factors or rules.
q) can collect information suitable for use determining environmental classification associated with a land base or product.

One or more of these and/or other objects, features, advantages, and aspects of the invention will become more apparent with reference to the accompanying specification.

In one aspect of the invention, the system includes a portable digital device. A geographic position device is in operative communication with the portable digital device. Software resident in the portable digital device allows the following types of functions.

First, it presents to the user a pre-designed data collection template. Secondly, the template presents a format which prompts the user regarding certain relevant or correlated queries regarding the particular call or investigation. Third, it places user-entered data in a data base. Fourth, it allows storage, communication, or transfer of data as selected for use or display.

The portable digital device allows an easy and efficient method of capturing data. The pre-designed data collection templates limit subjectivity. The captured data should reflect more facts than perceptions. The digital device allows easy and efficient storage of the captured data and access for further use.

At a general level, one aspect of the invention relates to an efficient, consistent way to capture and share geo-referenced crop information. One embodiment relates to field service call information. One embodiment utilizes digital/electronic capture and sharing of information, for example, with a personal digital device (PDA) having an operatively connected global positioning system (GPS) receiver which can be data synched with a central server and database. The PDA displays standardized, pre-designed templates/cues to the worker to promote more standardized information gathering from each service call. It also promotes the capture of information that is more like facts than individual perception, and which is easy, efficient, both in the capture of data, its storage and archiving, and its later access by and/or distribution to authorized persons.

One use of the invention could be to collect data regarding a number of different fields and use the information relative to each particular field, or integrate the information and analyze it. For example, information collected from individual field service calls for a relatively large geographic area could compiled and analyzed for such things as production, sales, marketing, research, development. One example of research and development would be use of environmental classifications for certain varieties of a crop or for certain geographic areas or for areas of similar environmental characteristics. Certain varieties or certain desirable characteristics of a variety could be suggested for better performance for a certain environmental classification.

In one aspect of the invention, captured standardized observations are gathered and captured electronically and posted to a website periodically (e.g. each day). In almost real time, interested persons could access, analyze and use part or all of the information form individual service calls, or integrated or combined information from a plurality of service calls. They could also mine the collected information for designated information and use it. One example would be to plot out specific information about pests or diseases that have been observed across a relatively large geographic region to see or predict trends in expansion of the pests or insects, and thus allow beneficial decisions to be made to try to combat what otherwise might be unknown or unappreciated risks to crops. Allowing combination of information at a central location, with a more standardized system, promotes better accuracy in identifying trends.

### III. BRIEF DESCRIPTION OF THE DRAWINGS

FIGS. 1A-E illustrate an overview of a system for capturing data from a field service call by an FSA according to one aspect of the present invention.

FIGS. 2A-H diagrammatically illustrate basic hardware and software that could be used for a system such as indicated in FIGS. 1A-E.

FIGS. 3A-E represent examples of template formats that can be displayed to the customer service representative on a personal digital device for data gathering during a field service call.

FIGS. 4A-D are exemplary reports generated from integrating data from a number of service calls through a plurality of field service calls to various customers.

FIG. 5 is a diagram depicting the system architecture for an exemplary embodiment of the present invention.

FIG. 6 is an alternative system architecture according to the present invention.

The file of this patent contains at least one drawing executed in color. Copies of this patent with colored drawing(s) will be provided by the Patent and Trademark Office upon request and payment of the necessary fee.

### IV. DETAILED DESCRIPTION OF THE EXEMPLARY EMBODIMENT

A. Overview

To better understand the invention, a specific exemplary embodiment will now be described. Frequent reference will be taken to the accompanying drawings. Reference numbers will sometimes be used to indicate certain parts or locations in the drawings. The same reference numerals will indicate the same or similar parts or locations throughout the drawings, unless otherwise indicated.

B. General Environment

The exemplary embodiment will be described in the environment of an agricultural seed company, and its research and development, production, sales and marketing, supply, and customer service related to agricultural seeds. The general field of art is agronomic service calls and observations by FSAs. This field of art relates to the personal visits or calls that FSAs make to observe and diagnose potential crop problems or issues for a plurality of fields or farmers.

It is to be understood, however, that this exemplary embodiment is not intended to limit the invention to this particular environment. It is intended that the invention is applicable to a number of information gathering applications, including those not involving agriculture.

C. General System

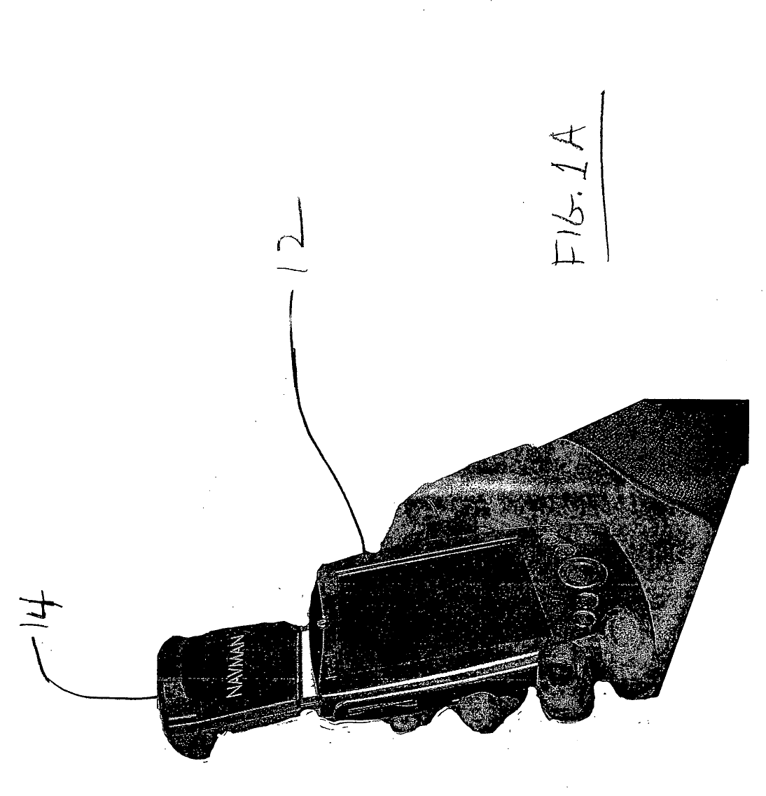

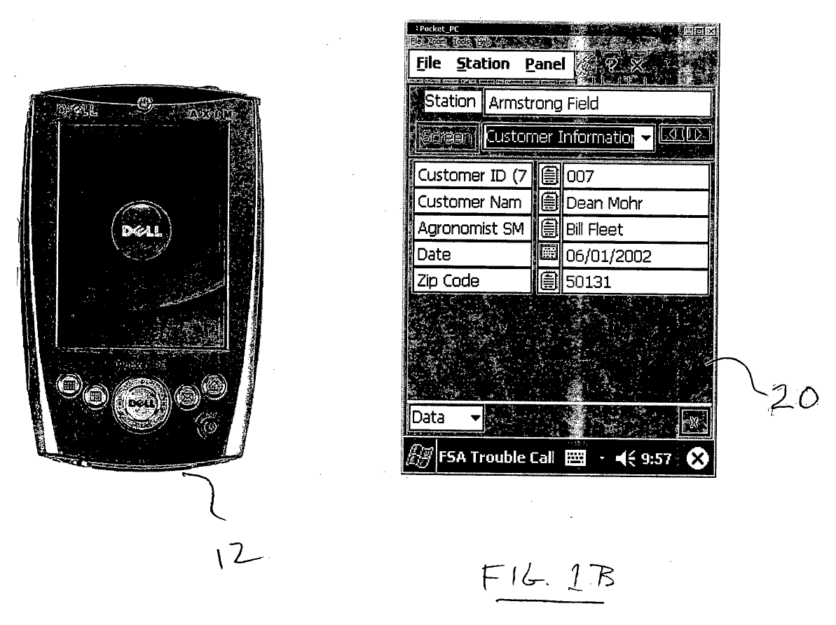

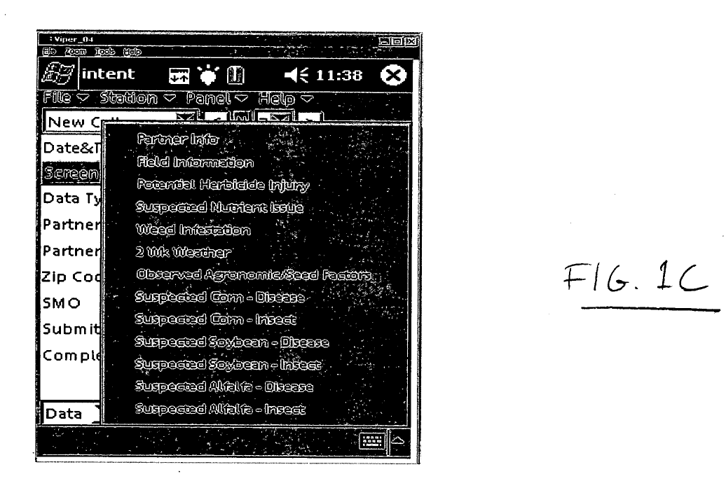

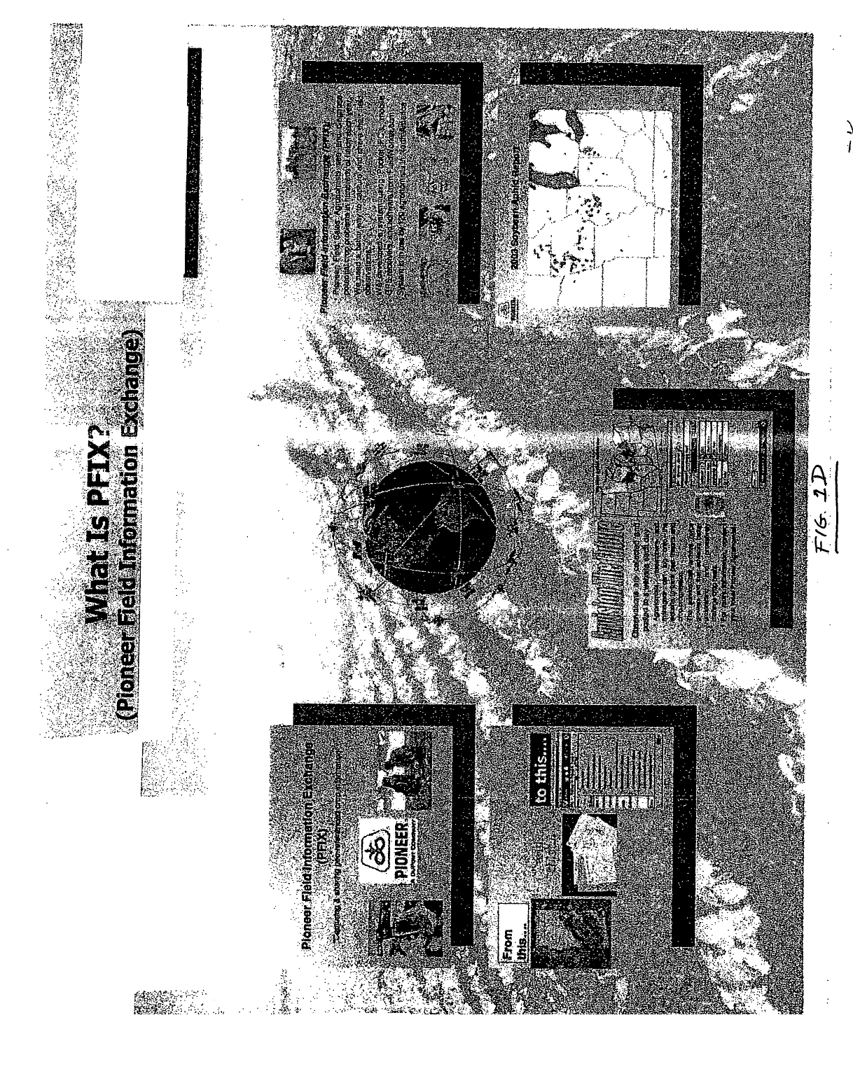

FIGS. 1A-C illustrate basic concepts regarding an exemplary embodiment of the system. As indicated in FIG. 1A, what will be called system 10 is a field information exchange system allowing FSAs to personally visit a field and capture geo-referenced information about the crops in the field through a PDA 12 with a GPS unit 14 coupled to it (externally or internally). Pre-designed template(s) 20 is/are displayed on PDA 12 with fields and queries to be answered by the representative (see FIG. 1B and 1E for examples of portions of such templates). Navigation around the program that facilitates the display and filling out of the templates can be via screen menus and icons, as is conventional. FIG. 1C shows an example of a menu from which the FSA can select to navigate through the programming. This menu shows various agronomic categories to select from. Instead of using his/her memory, a blank piece of paper, or a hodge-podge of ad hoc forms, the system allows the FSA to have personal exposure to the field, but efficiently and in a systematic way capture relevant data about the call in a form that can be useful not only for the particular field or farmer related to that call, but for other purposes.

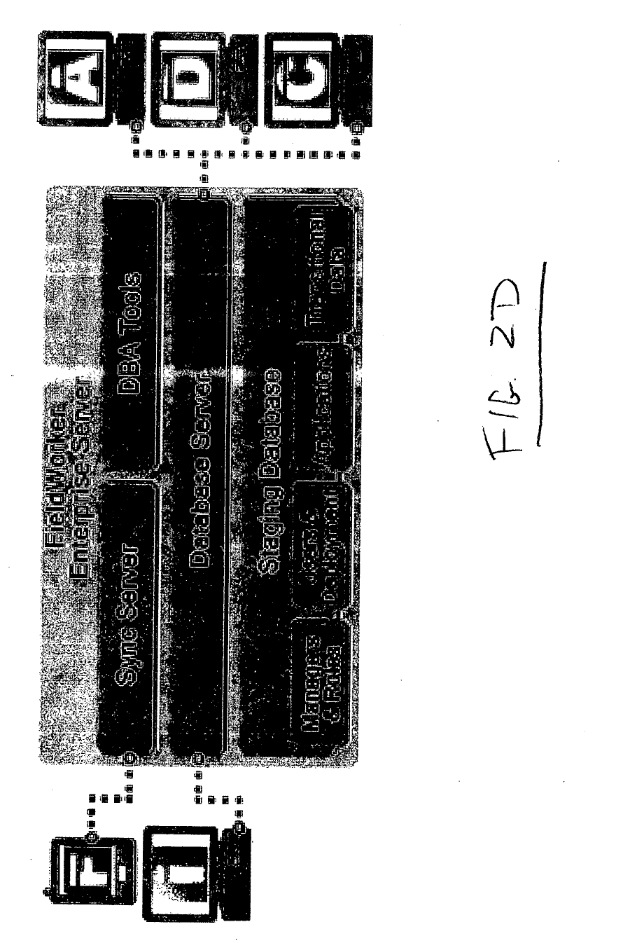

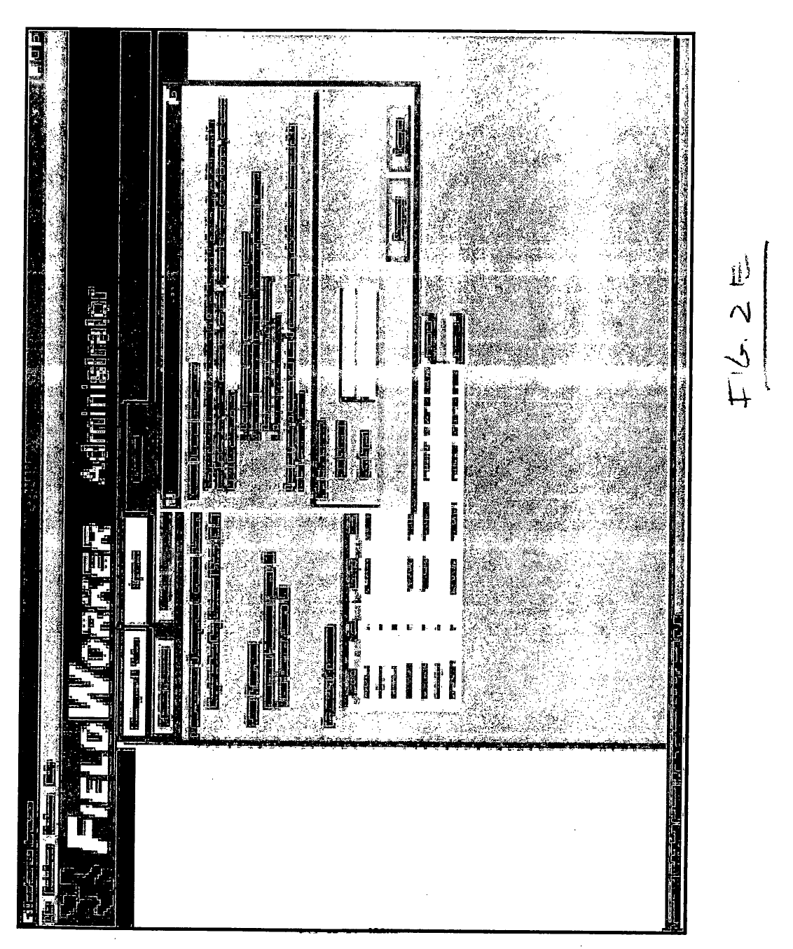

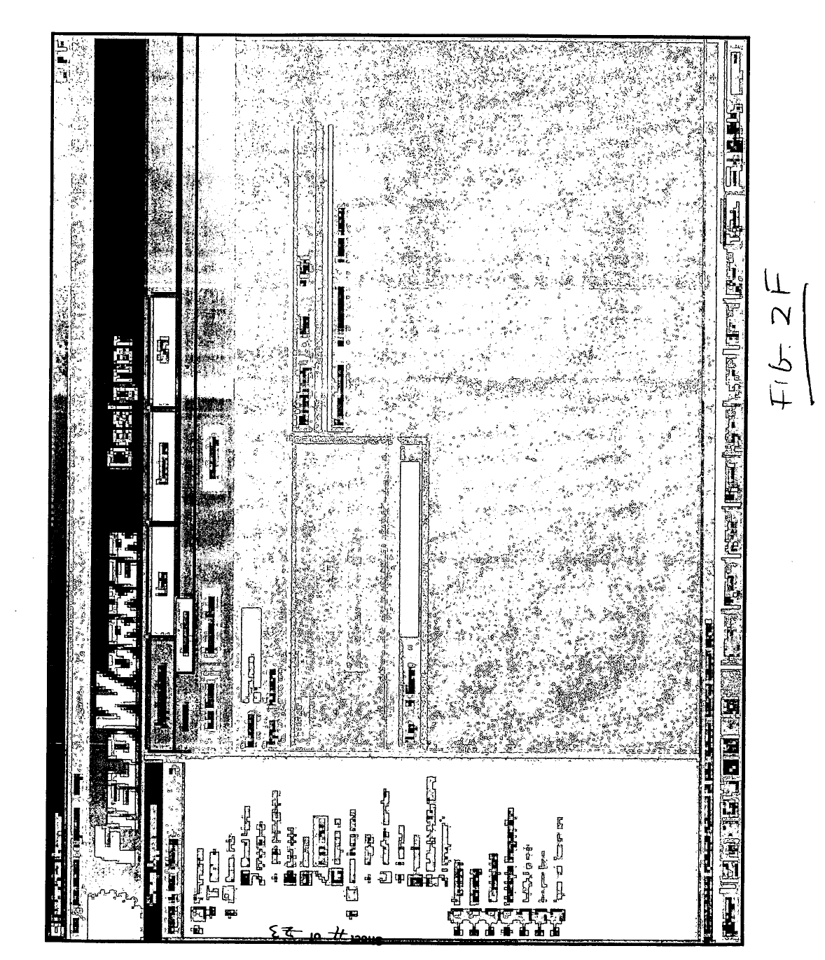

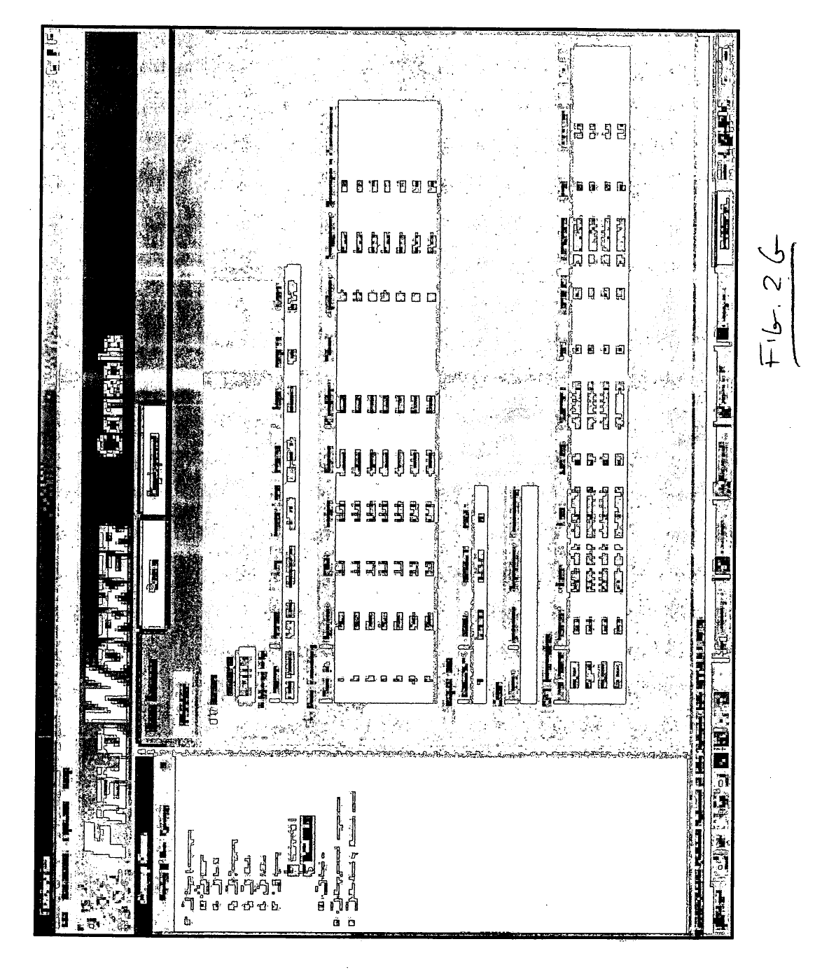

The programming in the PDA can be designed to help efficiency and accuracy of data entry. For example, menus or icons can be presented in pre-determined order to step the FSA through a field visit. It can prompt the FSA to enter the appropriate type of crop to then enable the appropriate template 20 for that crop (see examples of different templates for different crops in FIGS. 3A-E). It can automatically populate certain fields of the template (e.g. FSA i.d., time/date, geo-position) or prompt or present icons that can be selected by the FSA and then which automatically populate a field or fields of a template, and thus avoid errors if the FSA manually entered data.

The system allows capture and sharing of geo-referenced information. In one example, an FSA enters field service call observations, but in a pre-designed, systematic, standardized way that deters subjectivity and bias of the individual FSA.

Observations about a field of corn or soybeans could include, for example, observations about (a) herbicides, (b) nutrients, (c) weeds, (d) weather patterns, (e) disease, and/or (f) insects. The FSA selects a template appropriate for the field and crop. FIG. 1C indicates a few examples of subject matter or cues in a template.

The pre-designed template(s) facilitate the fact-based data capture of the field service calls. FIG. 1B illustrates a PDA screen with one portion of a template. It indicates that the FSA will be cued or prompted to enter information which identifies the customer and then documents facts about the call; e.g. who, what, where, when . . . . As can be appreciated, the template or other template would display questions, checklist and/or cures that the FSA can systematically go through to collect information about the call. FIGS. 3A-E are examples of templates for different crops. The template can be resident in memory of the PDA (or otherwise obtained).

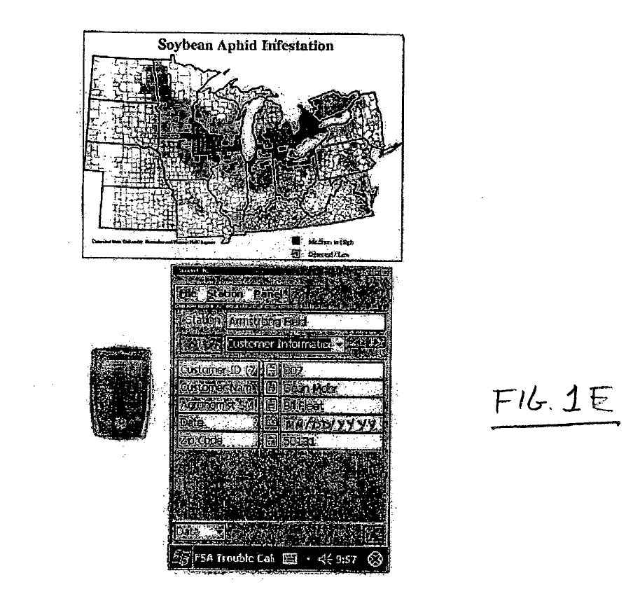

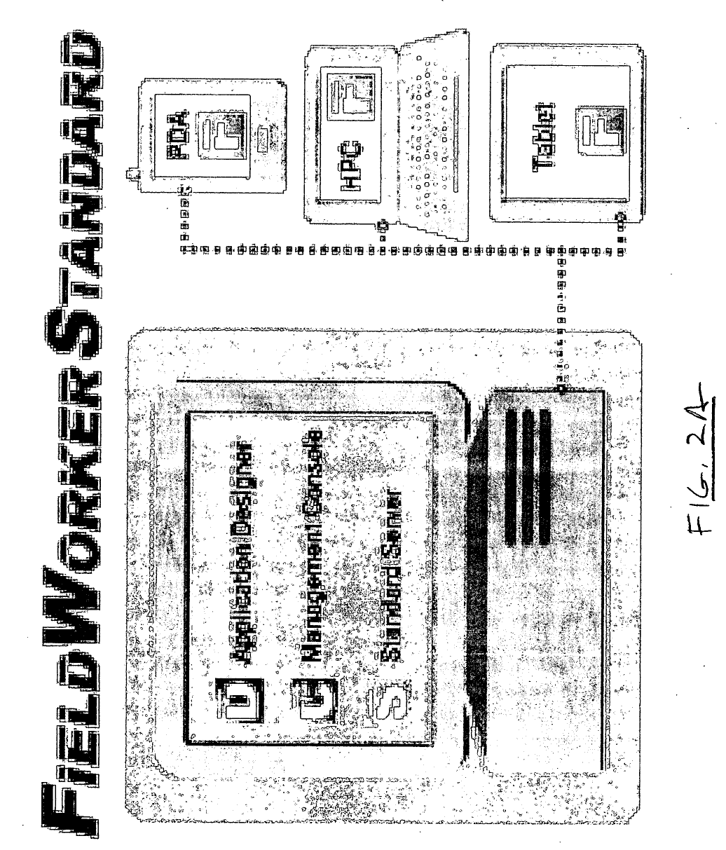

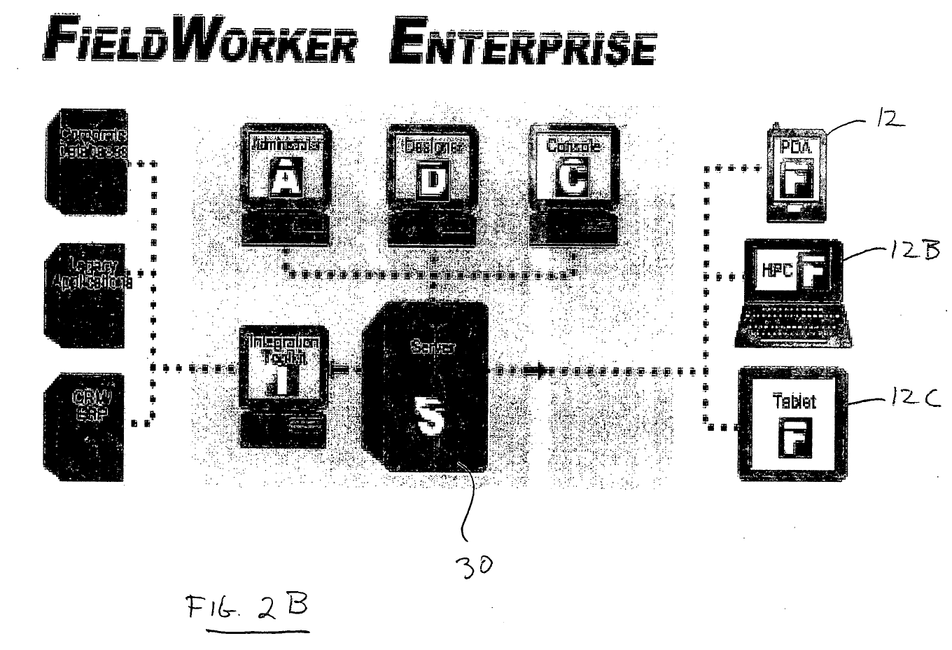

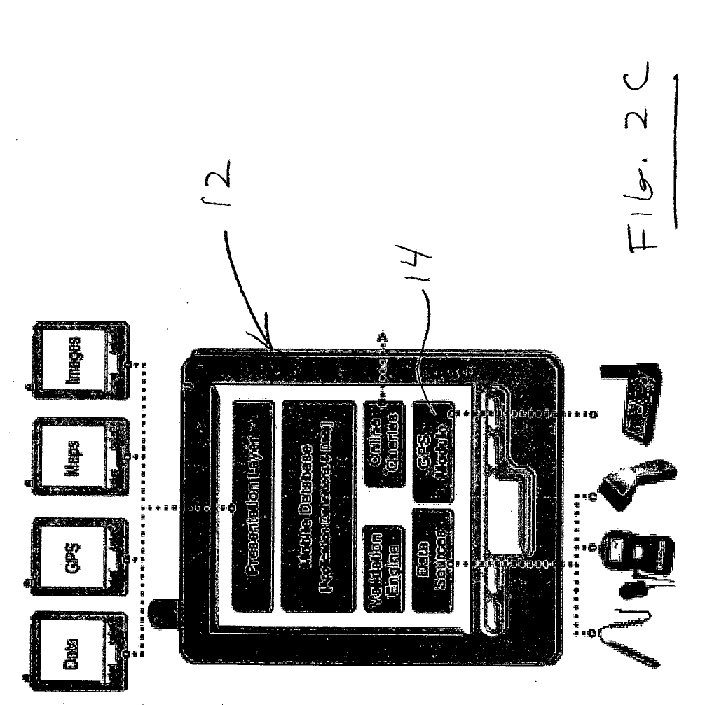

FIG. 2D diagrammatically illustrates use of the internet to allow sharing of collected data. Plural FSAs, each with a PDA with geo-referencing, collect data from calls and communicate it to a central server which can be accessed via the internet. The data can be mined or manipulated in many ways. For example, as indicated in the Figures, maps, diagrams, plots, and similar visual representations of cumulative data can be created to assist in a macro-analysis of trends.

As indicated at FIGS. 1A-E, the FSA has a fully portable, compact, easy to use digital device which prompts the FSA with relevant data collection queries and stores the entered data. Further, it presents templates which extract data in a form that emphasizes fact gathering as opposed to perceptions of the representative. As indicated in FIG. 1D, device 12 can store, display, categorize, and even communicate the data. The objects of the invention pointed out in the Summary of the Invention above are met by this exemplary embodiment.

The captured data can be communicated to a central device. An example would be server connected to the Internet. The captured data from a field service call can be displayed, exchanged, or transformed. For example, as illustrated in FIGS. 1D and 1E, graphic displays can be generated based on cumulative data from a plurality of field calls. Such data can provide intelligence that can be advantageously used by the seed company or farmers. Each device 12 would store, in retrieval fashion, data related to a field call. It would be organized in a systematic and logical way. The FSA can easily call up and then use the captured data to reconstruct the field call and its relevant aspects. Storage of the data can either be in device 12, to some degree, or downloaded to another device, such as a PC, mainframe, or server, and archived.

But further, the data can be “shared” by posting or making it accessible via a web site. Using conventional hardware and software, field call information can be accessed by anyone connected to the Internet and, if required, having authorization to view the information. This can allow remote study of a farmer's problem, or remote collaboration. By well-known methods, each PDA could communicate information to a central database or server, and could synch up to the server.

But still further, data from a plurality of field service calls can be consolidated, integrated, or otherwise processed to provide a broader function than just data related to one field service call. For example, the incidence of a particular insect infestation can be graphically displayed on a map by showing each location where such an insect was observed in a set of field service call reports. As shown in the lower right hand graph of FIG. 1D, for a particular year, the incidence of soybean aphid can be displayed graphically. As shown in the map of FIG. 1E, the data can be processed more to show not only location, but also graphically indicate with color the magnitude of infestation by geographic area. Some of the benefits include the fact the information is geo-synched, date synched, etc. Because data can be captured and communicated to a central location quickly, FSAs, researchers, or managers can log onto the website and evaluate data or processed data. In the example of the map of FIG. 1E, they can track pest threats and infestation progression in almost real time. It can also help plan and manage the various aspects of the business; research, sales and marketing, supply, and customer service.

Because the service call observation data is married to geographic position (and other information), the system can automatically provide interested persons with helpful information. And, because of the systematic design of the system, it provides an improved way of accumulating a reliable record of field service calls, which can then allow a more accurate and useful knowledge base from collective information on a variety of points.

D. Apparatus and Hardware

FIGS. 1A-E illustrate the basic hardware of exemplary field service call system 10 involves PDA 12 with the GPS unit 14. The GPS component 14 allows geographic positioning data (e.g., within three meters or even less) to be derived and correlated with data collected for a specific field during a specific call.

In one example, PDA 12 is a Pocket PC brand device available commercially. It also could be a Palm brand device or a portable PC. A further alternative would be a Tablet PC type digital device. As indicated in FIG. 1A, GPS device 14 can be a NAVMAN device adapted for use with pocket PC. Other alternatives are commercially available.

PDA 12 is web enabled and uses a GIS tool to communicate to a service call data base. There can be a web based data center. Communication of PDA 12 with a central server can be wireless, via land line, or by download to a computer and then transferred to the server. PDA 12 can have a radio frequency transceiver/antenna and be connectable to the server via radio waves. One example is via a widely distributed network, for example a global computer network, e.g., the Internet, by wireless technology, such as is known. Communication could also be via a proprietary wide-area network (WAN) or local area network (LAN), or some other method.

E. Software

Software resident in PDA 12 can effectuate relevant functions for the system. In this example, the software is FieldWorker Enterprise brand commercially available from FieldWorker Products Limited, 1092 Islington Ave., Toronto, Ontario, CANADA M8Z 4R9. FIGS. 2A-H provide basic information about functionality, communication, and other aspects of this software. These figures are intended to illustrate generally the nature, components, functionality, and connectivity of Fieldworker Enterprise brand software (e.g. version 5.1 or 6.0).

Details can be found at http://www.fieldworker.com/prod_enterprise.html. It can be applied to system 10 by programming desired template formats and queries. Such programming is within the skill of those skilled in the art.

As can be appreciated by FIGS. 2A-H, this software allows the type of functions needed for system 10 according to the present invention. It can also handle a plurality of separate PDAs 12 with a plurality of FSAs in different locations across the country. Such a system and software would allow data capture and then storage and manipulation of large amounts of data from individual field service calls.

One example of the functionality of PDA 12/GPS unit 14 under FieldWorker Enterprise 5.1 is illustrated at FIG. 2C. PDA 12 would include a presentation layer, a mobile data base, a GPS module, and other aspects. Data input could be via a stylus, touch screen, or other modes and methods known in the art.

FIG. 2B illustrates how PDA 12 (or alternative portable devices such as portable PC 12B or tablet PC 12C) could be used by a FSA on-site of a field and communicate to a remote central server 30.

FIG. 2D illustrates a diagrammatic view of server 30, such as of the type well known in the art. FIGS. 2E-H illustrate tools, functions, and combinations possible with Fieldworker software or usable with server 30, again such as is known in the art.

It is noted that FIG. 2A illustrates a block diagram of FieldWorker Standard 5.1, for systems that would communicate to a PC. FieldWorker Enterprise 5.1 (FIGS. 2B) is a more robust and sophisticated system. It is tailored for a relatively large number of PDAs 12 or other data gathering devices, and has substantial flexibility. Essentially the central computer or server 30 is connected to the Internet. It has access to one or more data bases. It can also be connected to one or more host computers. The host computer could be a computer at an entity controlling server 30.

As configured at FIG. 2B, system 10 can service a plurality of distributed PDAs 12 at a plurality of distributed service call or field locations. PDAs 12 could be relatively close together or widely distributed, across a region, country or globally.

Server 30, being connected to the Internet, is thus accessible by authorized persons. Those persons could be widely distributed, even globally. Thus system 10 can service multiple field sites and provides a communicate link between those multiple sites in a central processor, e.g., server 30.

As mentioned previously, the software allows presentation, via a graphic user interface (GUI), of one or more pre-designed templates 20. For example, the GUI of PDA 12 could display data, GPS information, maps, or images, or any combination of the same.

F. System Architecture

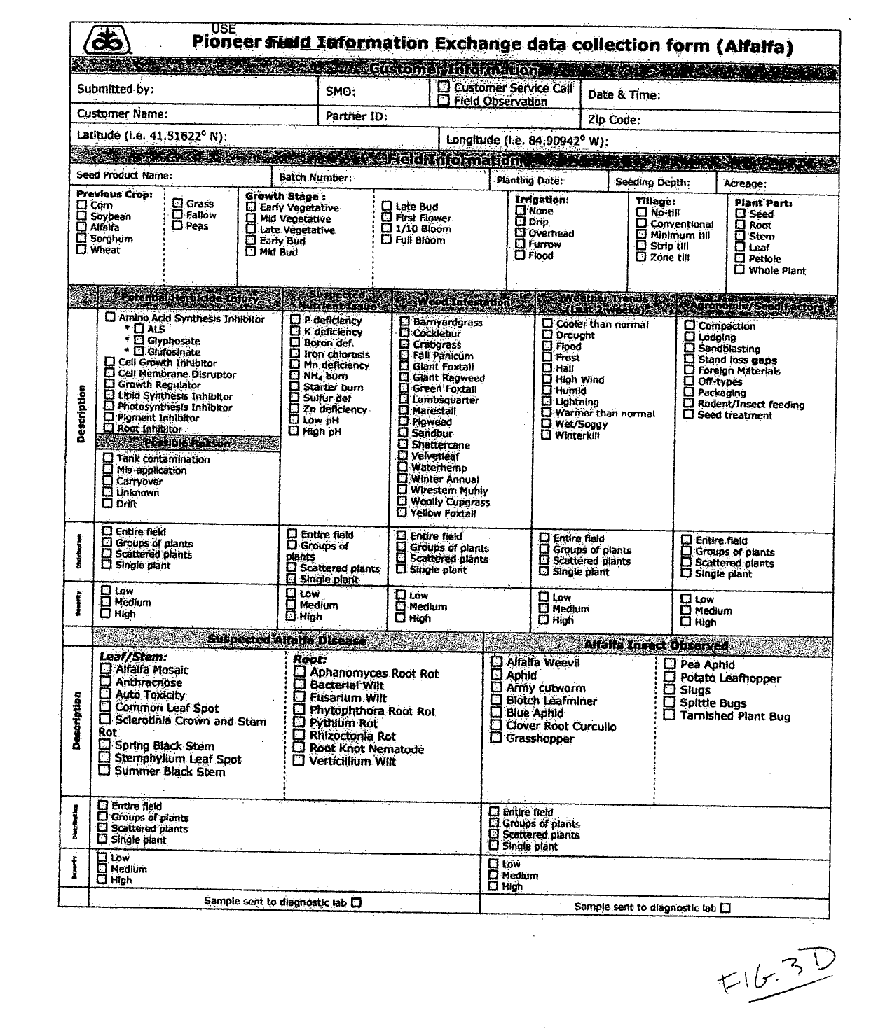

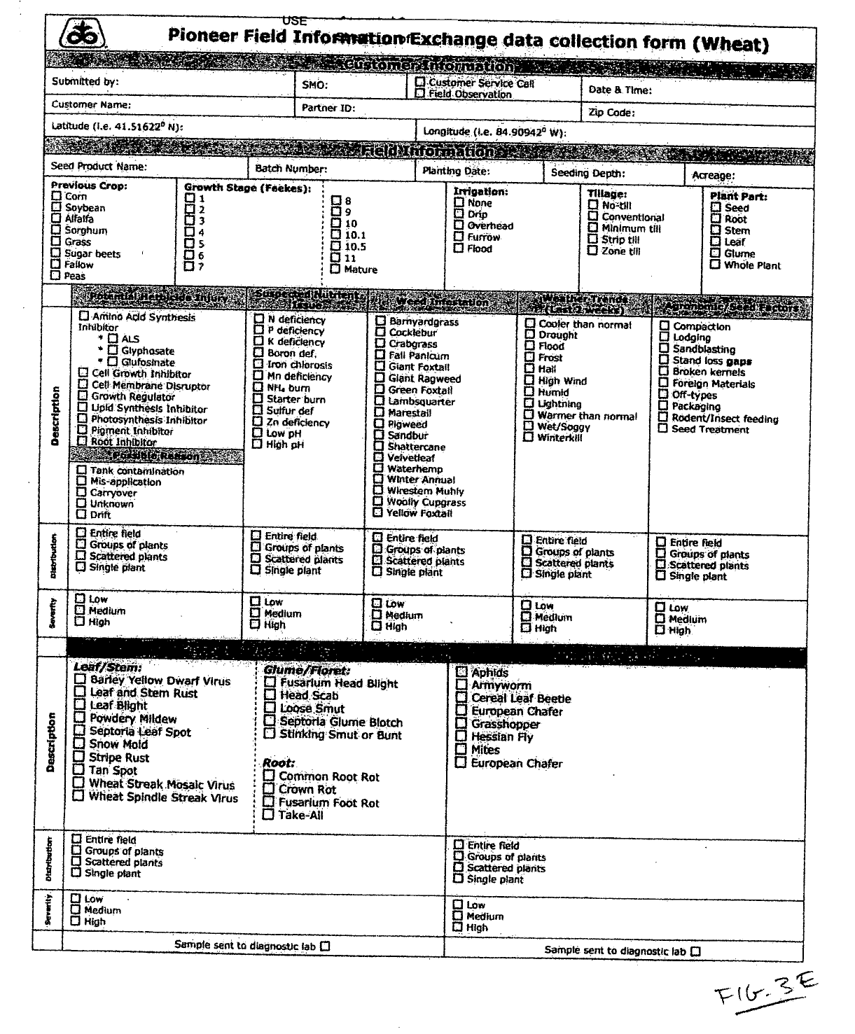

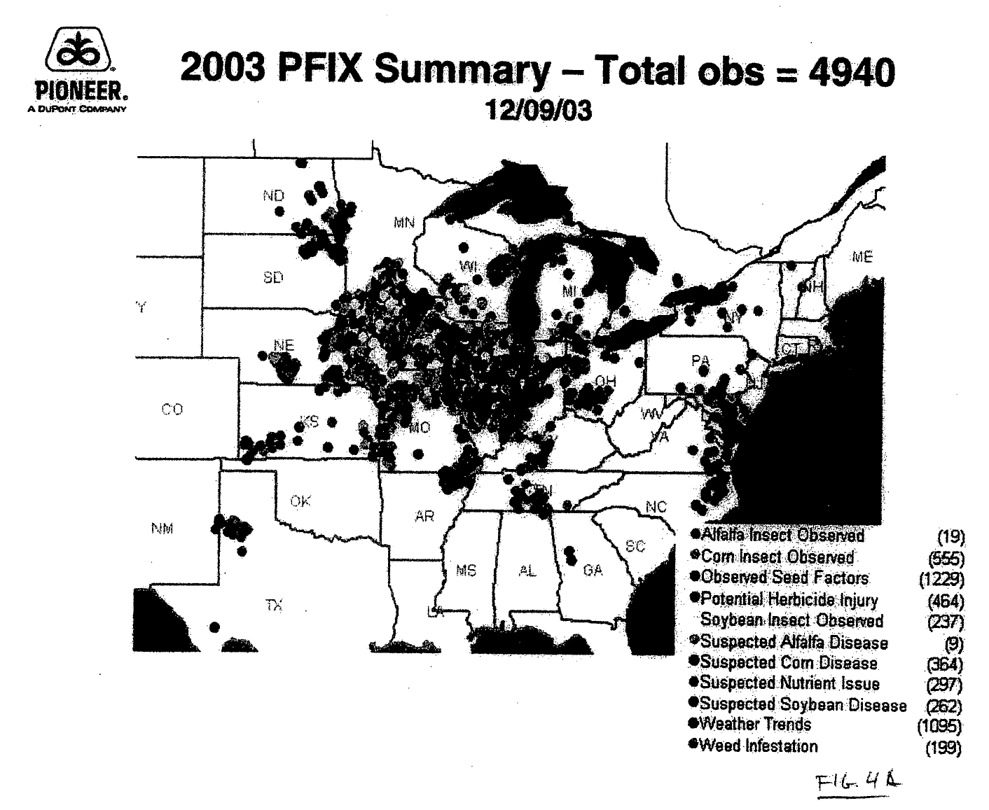

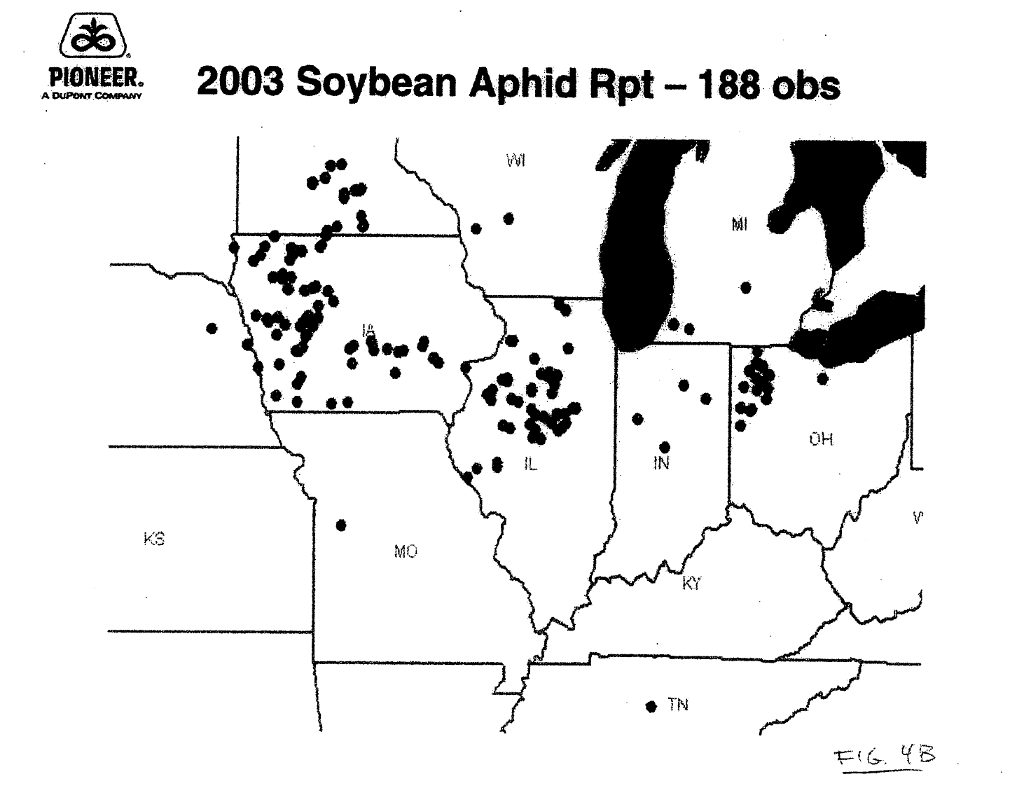

FIG. 5 diagrammatically depicts more specifically one form system 10 could take. Connectivity between one or more PDAs 12 and website server 30 can be via the components illustrated.

In particular a PDA 12, with its GPS module capable of obtaining geo-position information from a GPS satellite network 15, could be enabled for access to a virtual private network (VPN) controlled at server 24. The VPN has a security system that requires access by only authorized users. It requires a security access code (e.g. secure numeric i.d.) to authenticate a user. Server 24 could be physically or virtually located relative to a central location 22, for example, internally of the company for which the FSAs 16 work. A lap top computer 18 could be configured with a synchronization cradle (not shown but well known and commercially available) for PDA 12 and with a communication line or channel to the VPN via server 24. Server 24 can also function as an email server for lap tops 18.

In this embodiment, PDA 12 and lap top 18 are configured as follows. The PDA can have a synchronize function. When the FSA dials or otherwise attempts access to the VPN (e.g. to synchronize, for email, etc.), if the VPN senses PDA 12 is in its synchronization cradle and if it is authenticated relative to VPN, it commences an automatic synchronization of the PDA and the FieldWorker (“FW”) database/server 26. This combination grabs and flows pre-determined data from PDA 12 to database 26 by passing it through lap top 18. Thus, database 26 is updated automatically from the one or more PDAs 12 in a relatively efficient manner each time FSA connects to the VPN for email without the FSA having to remember to request it, and without requiring more complex or time-consuming procedures.

The software can also allow the sending of updates or data to the PDA.

Server 30 would be in operative communication with database 26 and website 28 respectively. As indicated in FIG. 5, periodically (here nightly) processing could occur automatically to make each day's collection of field observations by FSAs 16 with PDAs 12 available in a format at server 30 such that any authorized user could access the daily updated database information via the internet. In this way, daily up-to-date data is available to authorized users at any location with internet access. Fieldworker data is essentially automatically swept from database 26 and put in an appropriate form that can be fed to and used by web site 28.

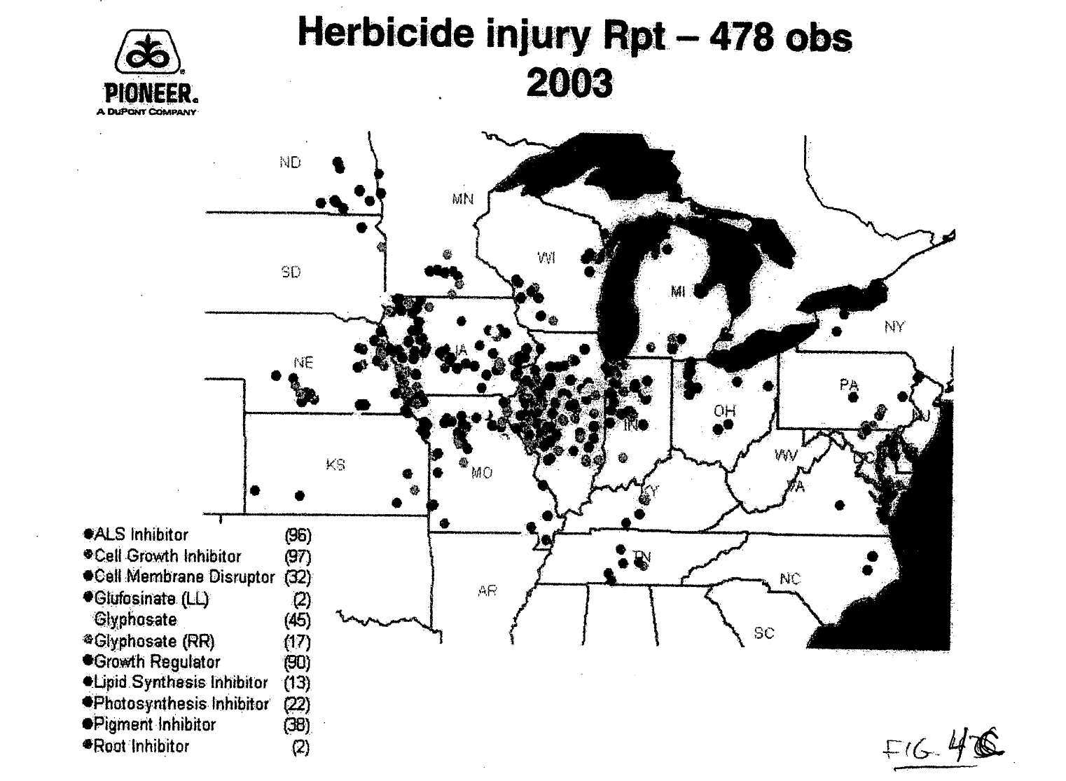

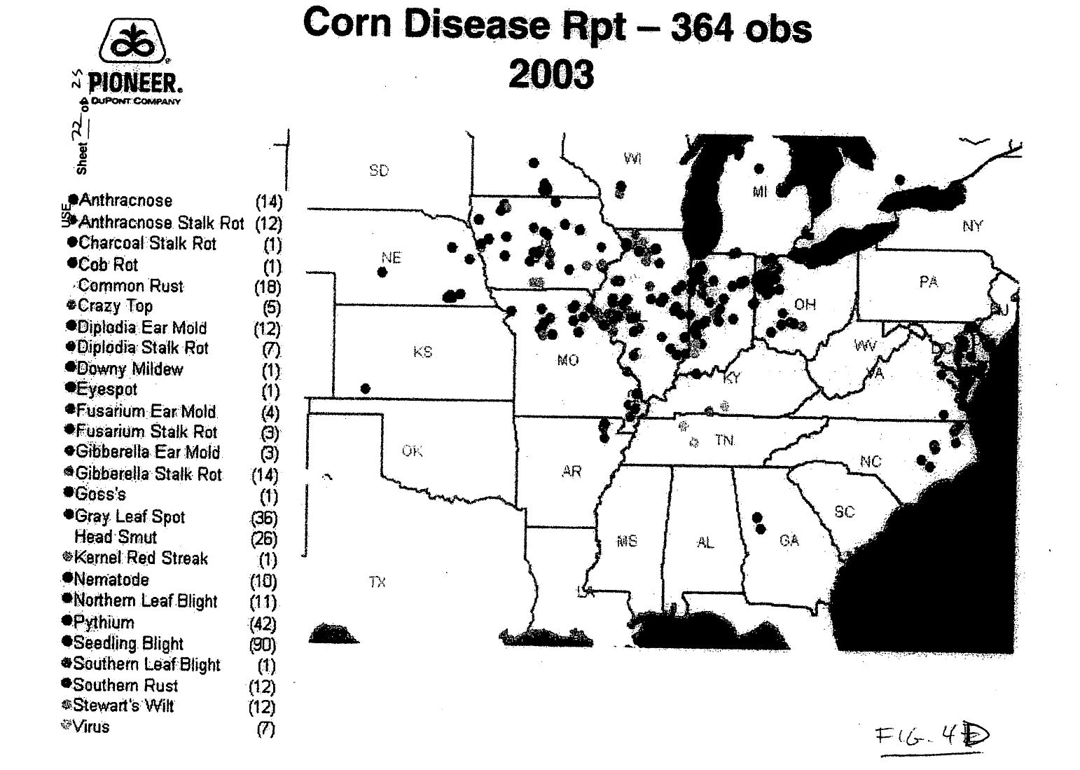

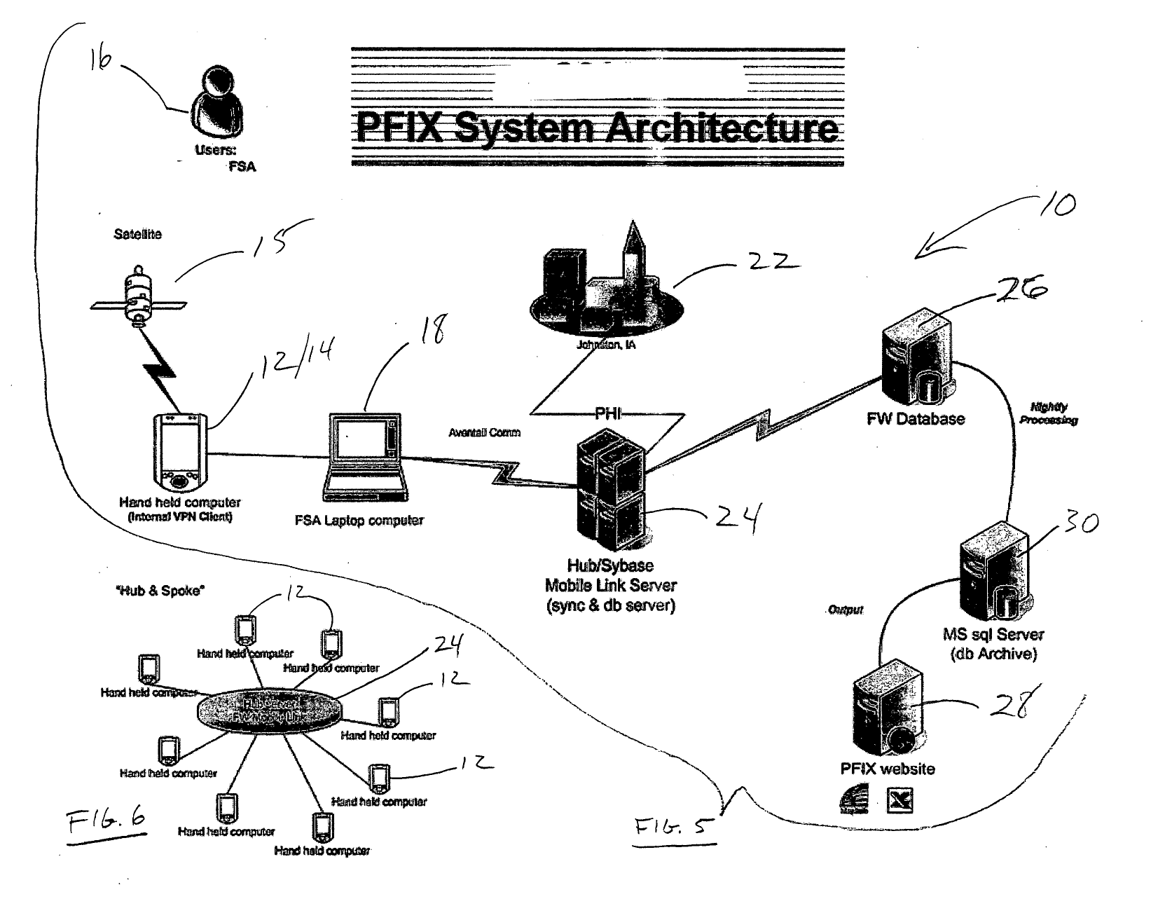

FIG. 6 diagrammatically illustrates an alternative system architecture for system 10. Plural PDAs 12 are connectable to server 24 through a hub and spoke configuration, well known in the art. This can be a preferred set-up, for example, in geographic regions where FSAs will not likely have or use lap tops 18. PDAs 12 could be configured with modems (wireline or wireless). Server 24 could be connected to database 26, server 30, and website 28, as shown in FIG. 5. On the other hand, server 30 could function to hold database 26 and be the point of access by any of the users of consolidated data. Other system configurations or architectures are, of course, possible.

G. Website

A web site is created and is accessible by authorized password protection by authorized persons and subscribers. The web site can have different modules.

The web site can be configured to be updated periodically. For example, information can be updated and posted every day. Other time periods are possible. Importantly, the system 10 provides the ability to link data from the PDAs 12 to the server as soon as the FSA can get it to the server. If done in an expeditious manner, system 10 in relatively real time accumulates data from all the PDAs. That data is therefore available for generation of reports or displays.

Website 28 can be used by authorized users to what might be called “mine” the available data. Queries can be made for selected data. An example would be to extract all field calls for a certain FSA for a given week. Another example would be to extract all field call data about soybeans in Iowa for a given time period.

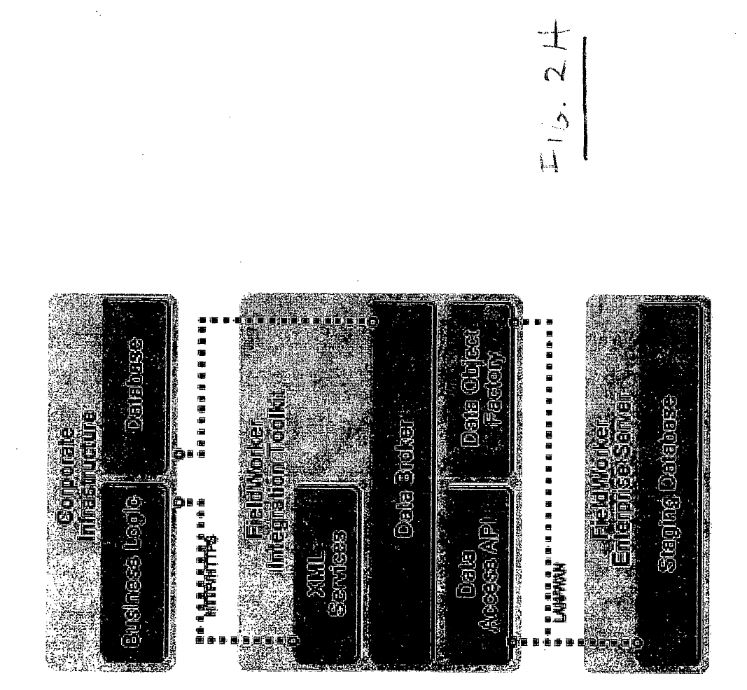

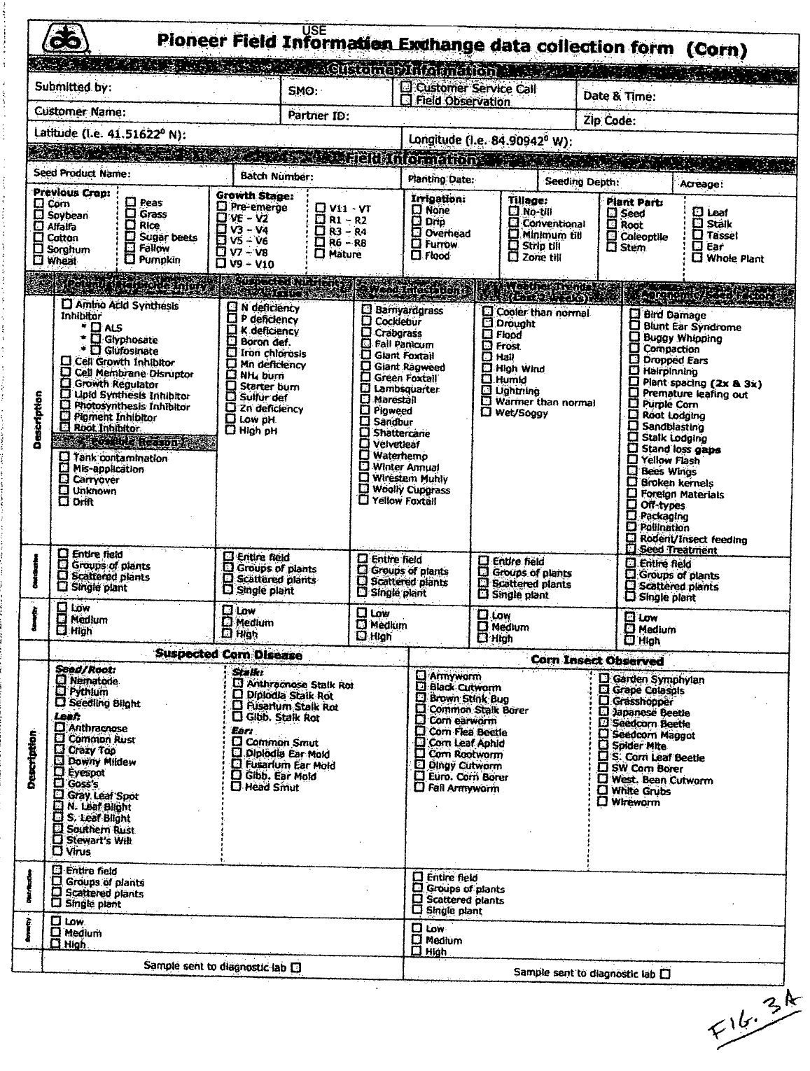

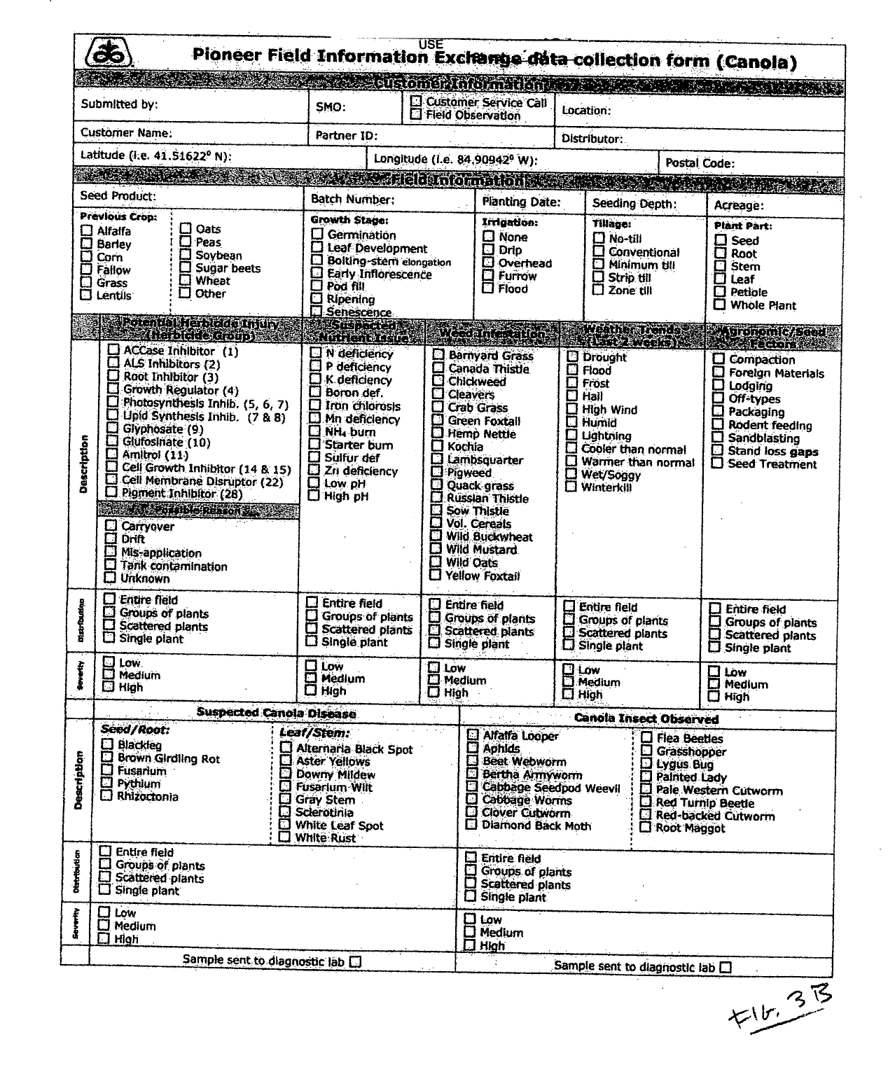

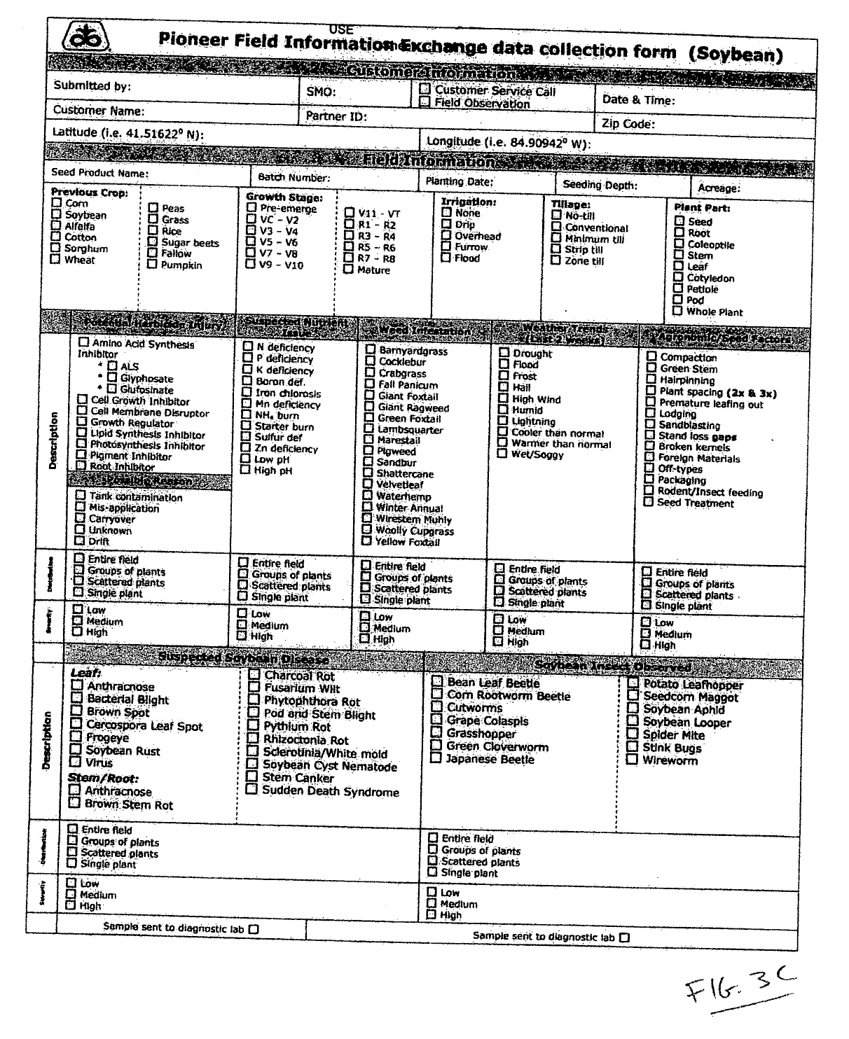

Output to website 28 from server 30 could be in a variety of formats. As indicated diagrammatically in FIG. 5, in this embodiment the output could be in the form of a map (e.g. using MapInfo™ software) or in a spreadsheet (e.g. using Microsoft Excel™). Examples of maps are seen at FIGS. 4A-D; colored dots with color-coded key on the map to indicate geographic locations.

H. Templates

FIGS. 3A-E show examples of different template formats that can be displayed on the GUI of PDA 12. Templates 20 are pre-designed to have a systematic format. In this embodiment, that systematic format is consistent through each of the different templates 20.

Each of FIGS. 3A-E relate to a different crop (see red lettering at upper right-hand corner of each). For example, FIG. 3A is a template 20 for data collection regarding field corn. It is dedicated to a particular crop, namely corn.

The template is divided into two major color-coded sections. The first (see salmon colored headings) as a “Customer Information” portion and a “Field Information” portion. The “Customer Information” portion provides database fields to fill in regarding such things as which farmer is visited, for what purpose (customer service call or field observation), and GPS geographic position of the field. The first section prompts the FSA to enter customer information relative to the service call. By conventional data entry through PDA 12, the FSA name, the type of call, date and time, customer name and address, and GPS geographical data can be entered.

The “Field Information” portion presents four sub-sections; several lists relating to crop and field data; several lists or checklists with descriptive language relating to crop or field conditions; a distribution rating for each of the crop or field condition lists; and a severity rating for each of the crop or field condition lists. Note how even the first sub-section has descriptive words under each heading that allows the FSA to scan through and check the most appropriate answer. The “description” row of the second sub-section details, in descriptive language, different crop and the field conditions—what seed product name is planted, when it was planted; seeding depth, etc. The “Field Information” section of template 20 prompts the user to indicate seed product name, batch number, planting date, seeding depth, and acreage. It then provides pre-designed, limited choice check-off boxes for “previous crop”, “growth stage”, “irrigation”, “tillage”, and “plant part” (the part of the plants that may be of concern relative the field call). As can be appreciated, the information prompted from this section is pre-selected and designed for corn.

The second sub-section under “Field Information” provides descriptive lists relating to herbicides, weeds, nutrients, weather, and agronomic/seed factors. Note that lists again provide essentially a checklist for the FSA to go down and indicate the most appropriate answer. The lists or checklists have built-in intelligence in the sense they present a standardized set of cues or subject matter to the FSA to consider and they are descriptive. The selection and arrangement therefore promotes fact gathering and consistency, as opposed to more subjective information, regardless of who is entering the data and promotes. It also promotes uniformity of fact gathering by presenting the same descriptors and lists on a consistent basis across the set of FSAs making field service calls. Specifically, this sub-section for corn has check-off boxes and lists related to (1) “potential herbicide injury” (and the possible reason), (2) “suspected nutrient issue”, (3) “weed infestation”, (4) “weather trends”, and (5) “agronomics seed factors”. Those headings are distributed horizontally across template 20. The left-most vertical column allows the user to select the most appropriate “description” regarding these factors. This pre-designed arrangement therefore focuses the user on acquiring data related to observations about problems in the field. It also prompts the user to record whether the observed problem is distributed across an entire field or more isolated. It finally uses a fairly standardized inquiry of how severe the user rates the problem.

Also, the third and fourth sub-sections-are below each column of the second sub-section and are rating questions regarding distribution and severity of any of the matters that might be checked in the lists. Although asking for a rating by the FSA, the rating questions are similar to the descriptive lists because they are standardized in their options. Each FSA will be selecting between the same choices. These sub-sections prompt data entry regarding “distributions” and “severity”.

The second major color-coded section of the template of FIG. 3A (i.e. yellow headings) has three sub-sections; a first sub-section comprising descriptive lists relating to suspected corn disease or insects, and second and third sub-sections, again rating questions as to distribution and severity. Even though this section relates to what a FSA believes might be the cause of certain observed conditions, this second main section maintains a similar format to the first main section; (a) a set of subjects with descriptive lists and (b) ratings questions for each. Template 20 of FIG. 3A presents the user with queries regarding “suspected corn disease” and “corn insect observed” and prompts the user for a description of observed problem but also distribution and severity.

Note also that the template 20 of FIG. 3A has at the very bottom a cue or prompt of a different nature. It prompts the FSA to decide and document whether a sample is being sent to a diagnostic lab. This provides a fail-safe or reminder that otherwise might be overlooked or forgotten.

Of course, by conventional means, text, numerical information, or checkmarks can be user-entered into PDA 12. Alternatively, information can be transferred from internal sources in the PDA into the fields on template 20. For example, by instruction, geographic GPS position could be automatically populated into the appropriate fields in the Customer Information section of template 20. Likewise, the name of the FSA could be automatically entered into the appropriate field. A database of customers' names and addresses could be resident in PDA 12. Date and time could automatically be populated into the appropriate field.

The template therefore is a check list for a typical field service call for a corn field. But it is more. It presents a layout and format that encourages consistent, standardized, comprehensive data acquisition for a field. It essentially works not only to focus on a potential problem, but also documents certain characteristics, conditions, and other information about the field, whether or not related to the potential problem. It provides a data capturing format that can advantageously be used by system 10 for a number of functions.

The FSA therefore has the intelligence built-in to the lists to help document a service call field. But also, the template presents the queries in a systematic way, beginning with customer information, followed by field information, followed by observations about crop problems (and distribution and severity of the same).

The format of template 20 of FIG. 3A would not likely fit on one screen of a PDA 12. The programming would likely present it is pieces or some logical order.

FIGS. 3B-3E show alternative templates 20 for different agricultural field crops (namely canola, soybean, alfalfa, and wheat). Note how each has a consistent, standardized format like template 20 of FIG. 3A. Note how each has checklists relevant and dedicated to the particular crop. Note further that in this exemplary embodiment, the “Customer Information” and some of the “Field Information” headings are the same color coding (salmon) for each of the different crops, but the suspected disease and insect observed headings may differ for different crops (e.g. yellow for corn and canola, purple for soybean, green for alfalfa, red for wheat). This provides a visual cue to the FSA,

Note that not only can there be positional consistency between the different sections and columns of each template. There can be use of color or other visually perceivable cues to assist the FSA regarding distinguishing between sections and consistency between different templates 20.

For example, the bar that includes “customer information” on each template 20 of FIG. 3B-3E can be a consistent color. Different colors can be used for different sections on a form. Different colors can be used to indicate different crops on different forms. This could assist the FSA in making sure the correct template is being used for different crops.

The user would select from the PDA 12 memory which data collection form to use for a given field.

I. Operation

The basic operation of system 10 has been set forth above. At the service call crop field, the FSA selects the appropriate template 20 and fills it out via PDA 12. Data is captured in a database in PDA 12. It is uniquely identified with the farmer and the geographic location of the field. As indicated previously, the FSA can go to a next service call, select the appropriate template 20, fill it out correctly, and store it. This can be repeated for a plurality of service calls.

At an appropriate or selected time, whether remotely or back at an office, the FSA can communicate stored data in the PDA 12 to the server 30.

Thus, the captured data for service calls or field observations can reside in the PDA 12 and/or server 30. It provides a documentation of the service call. The FSA could call up all or some of the date on the GUI of the PDA 12. By appropriate programming, displays such as indicated at FIGS. 4A4E could be generated. They could be generated at the PDA (based on the data stored at the PDA), but more likely they would be generated at the server and displayable via the Internet.

For example, FIG. 4A illustrates data from almost 5,000 field observations. In this instance, the programming uses colored dots to identify certain information. In FIG. 4A, the number of alfalfa insect observations (nineteen) out of the 4,940 total observations are displayed. Each of the nineteen observations, because each is automatically married to a geographic position in PDA 12, automatically show on the map of FIG. 4A where they occurred in the same color of dot. FIG. 4A is a summary for essentially a year of observations. Thus, the viewer of the graphic display of FIG. 4A can quickly and easily see the locations and frequency of alfalfa insect observations for that time period.

Similarly, FIG. 4A can simultaneously visually display location and frequency for the time period of a plurality of other observations based on the approximately 5,000 field calls. They can relate to the same crop, or different crops (e.g. corn insect observations). They can relate to non-crop factors (e.g. weather trends or weed infestations). By programming design, various alternative displays of the data captured by the FSAs with their PDAs for the multiple field calls over that period are possible. FIG. 4A is basically a summary of all or many of the observations that would be made from a template 20 like in FIGS. 3A-E.

On the other hand, FIG. 4B illustrates the display of only incidence of one observation, soybean aphids, for a time period. FIG. 4C shows different type of herbicide injury observations for a period. FIG. 4C shows different corn disease observations for a year of observations in the United States.

As can be appreciated, by programming, any of a number of displays can be created.

The exemplary embodiment meets at least all of the stated objectives of the present invention. It not only can help the FSA, it can impact virtually all areas of the seed company as set forth below.

The pre-design and standardization allow data from various crop fields and crop types to be meaningfully used. For example, not only do combined reports like FIG. 4D show individually occurrences of a single disease, but show occurrences of different corn diseases on the same map. This could be important to research and development of new corn varieties or genetic modifications that take into effect not just one disease, but a combination of the same. Therefore, system 10 not only supports storage of data of different field calls, but display and analysis of the same. In other words, review of a plurality of different observations from a plurality of different service calls, when applied to a geographic map, may render discoveries or benefits not possible by analyzing the same observation from a plurality of service calls applied to the map.

The system can therefore provide both more short term and more long term advantages. The captured data can be “mined” to select certain information according to different needs or desires. It can be compiled, integrated, plotted, displayed, and/or mapped in a variety of ways.

The following are examples of features or advantages of the invention, as implemented in the exemplary embodiment:

Sales
FSAs are more effective . . . which can improve their quality of life.
Presents a consistent form . . . which tends to capture facts not perceptions.
Is a tool to enhance customer relationships.
Produces a record of real time, agronomic events (geo-referenced)
Is a metric tool to analyze the impact of service calls.

Marketing
Helps product placement
Helps customer tracking
Assists market identification and development
Allows tracking of the impact of service call(s)
Improves communication among FSAs
Allows sharing of observations.

Research
The present invention can be applied in research and development efforts to provide significant advances. In particular, the standardized data collection used can provide the basis for product trait analysis, provide a basis for show pest threats/agronomic trends, and be used in environmental classification efforts. The geo-referenced field observations can include biotic as well as abiotic observations. Knowing this abiotic information, or in combination with other information such as historic weather information, the land base can be given an environmental classification. For example based on soil pH, soil type, soil moisture, and historical weather information, the land base may be classified into a “Temperate Dry”, “Temperate Humid”, “Temperate”, or “Subtropical” environmental classification. Of course, the environmental classification can be based on biotic conditions, abiotic conditions, or both. In addition, the present invention provides for a method and system for the standardized collection of data about a plant type or seed type. So on an enterprise scale, the performance of each seed type can be examined with respect to each environmental classification in which it has grown. Based on this information, recommendations are made to determine which seed type(s) is/are better performing in each of the environmental classifications. Thus, based on the environmental classification of a land base, determinations can be made as to which seed types to grow in each land base. Allows product trait analysis
Shows pest threats/agronomic trends (including short or long term trends)
Provides possible linkage to environmental classification efforts
Adds value to the products.
Allows tracking and responses to diseases and insects (e.g. development of disease and insect resistant varieties or traits)

Supply Management
Gives heads-up on new problems
Provides assistance with issues like pest threats/agronomic trends/seed quality
Allows tracking of customer feedback on seed quality concerns
Allows sharing of information across FSA base

Legal Documentation
Allows efficient documentation, storage, retrieval, and organization of information regarding products, product placement, specific customers, and specific field service calls or issues
Can assist in liability defense.
Provides a central database with common form to track pests and agronomic events.

J. Options and Alternatives

It will be appreciated that the foregoing exemplary embodiment is but one form the invention can take. The invention can take many forms and embodiments. Variations obvious to those skilled in the art are included.

For example, a PDA has been discussed as one device to use with system 10. Other digital devices can be used, some of which are shown and described. However, the invention contemplates other devices and methods that allow portability, entry, and storage of information at the crop field, and which information can then be retrieved and processed.

Various methods might be used to derive geographic position and marry it to the captured data.

Various arrangements of components to facilitate a server and web site are possible. And, variations in the templates and displays are possible according to application.

It can therefore be seen that the invention meets at least all of its stated objectives. The prior way of using a notepad to record observations depended much on each information gatherer (e.g. FSA). Each has his/her own style, format, and way of recording information. With a notepad, the recorded information was hand-written and in the particular words of the particular person. It tended to be quite subjective and could be difficult or impossible for others to interpret (in fact, it could be wrongly interpreted). It tended to include more individual bias and opinion and less facts. It might not be consistent from field service call to field service call for the same FSA, and certainly was not consistent for different FSAs. It was also difficult to share, compile, or integrate with others or with other FSAs field service call data.

Another approach in the art is for each FSA or each company to develop some “forms” to use on field service calls. However, they tend to be a collection of plural forms (e.g. one for identification of the customer, one for field observations, one for insect observations, etc.) They may not be consistent between FSAs in the same company. It again relies heavily on the information gatherer, which introduces subjectivity and consistency issues.

Thus, the present invention addresses not only the efficiency of data gathering, but deters subjectivity and bias and encourages more fact gathering and consistency. This engenders a variety of post-data gathering uses and advantages. Examples are analytical uses, such as mentioned above, that can have a material beneficial impact for a company.

One example is discussed regarding “environmental classifications” and there use in assisting in research and development and/or in assisting customers to select seed with traits that best match with predicted future field and growing conditions. In this application, the term “environmental classification” is used in the sense described in U.S. patent application Ser. No. (not yet assigned) (Attorney Docket No. P07244US00) which has been incorporated by reference previously herein. Note how the term “environmental classification” can relate directly to environmental conditions. One example is historical climate (e.g. classify as “temperate”, “temperate dry”, etc.). Sometimes the term refers indirectly to environmental conditions. One example is yield (e.g. classify corn as “150-180 bushels/acre”, “180-200 bushels/acre”, etc.) Another example could be the presence of pests or disease, and classification accordingly. The invention can be used to help predict trends and thus help develop or select seed with the best traits for those trends.

Other devices or components can be operatively connected to the digital device (e.g. PDA). Examples would be other data input devices such as scanners (e.g. RF, EMF, bar code).

The system and methods described can be applied, of course, to other crops, including but not limited to sorghum and sunflowers.

1. A method of collection of data related to crop performance, comprising:
a. distributing a substantially standardized template for input of geo-referenced field observations;
b. compiling a collection of geo-referenced field observations from a plurality of sources in a plurality of locations based on the standardized template, wherein the collection of geo-referenced field observations include observations related to one or more seed types.

2. The method of claim 1 wherein the distributing is electronically distributing.

3. The method of claim 1 wherein the collection is an electronic collection.

4. The method of claim 1 wherein the standardized template is an electronic template.

5. The method of claim 2 wherein the step of distributing is distributing to a plurality of PDAs.

6. The method of claim 5 wherein each of the plurality of PDAs is associated with a field service agronomist.

7. The method of claim 6 wherein each of the PDAs is adapted for determining geo-position.

8. The method of claim 1 wherein the geo-referenced field observations include biotic information.

9. The method of claim 1 wherein the geo-referenced field observations include abiotic information.

10. The method of claim 1 further comprising using the geo-referenced field observations to determine an environmental classification of a field location.

11. The method of claim 10 wherein the environmental classification comprises characterizing a seed product or land base at least in part in relation to an environmental variable.

12. The method of claim 11 wherein the environmental variable comprises one or more of temperature, rainfall, yield, pest, disease, best crop for a particular field, best variety of crop for a particular field, or trend for any of the foregoing.

13. The method of claim 10 wherein the field location corresponds to one of the plurality of locations.

14. A method of collection of data related to crop performance for use in environmental classification, comprising:
a. distributing a substantially standardized template for input of geo-referenced field observations;
b. compiling a collection of geo-referenced field observations from a plurality of sources in a plurality of locations based on the standardized template, wherein the collection of geo-referenced field observations include observations related to one or more seed types; and
c. determining an environmental classification for each of the plurality of locations at least partially based on the collection of geo-referenced field observations.

15. The method of claim 14 wherein the environmental classification comprises characterizing a seed product or land base at least in part in relation to an environmental variable.

16. The method of claim 15 wherein the environmental classification comprises one or more of temperature, rainfall, yield, pest, disease, best crop for a particular field, best variety of crop for a particular field, or trend for any of the foregoing.

17. The method of claim 14 further comprising associating the geo-referenced field observations for each of the plurality of seed types with genetic information associated with each of the plurality of seed types.

14. The method of claim 14 further comprising selecting at least one of the plurality of seed types for a field location based on the geo-referenced field observations and the genetic information.

15. A method of collection of data related to a crop in a field comprising:
a. carrying to the field a portable digital device and a geo-position device that is in operative communication with the portable digital device;
b. displaying a template pre-designed relevant or correlated queries regarding the field and the crop in the field, at least some of the queries including a checklist;
c. entering answers to the queries on the portable digital device; and
d. storing the answers in a digital storage medium.

16. The method of claim 15 wherein the template comprises a plurality of sections, at least one section relating to customer and field identification, at least one section relating to condition of the crop in the field.

17. The method of claim 16 wherein the customer and field identification comprises information regarding one or more of:
a. person entering the answers;
b. customer name;
c. field location;
d. date and time; and
e. reason for visit to field.

18. The method of claim 16 wherein the condition of the crop in the field comprises information regarding one or more of:
a. herbicide injury;
b. nutrient issues;
c. weeds; and
d. weather.

19. The method of claim 16 further comprising another section related to disease, disease resistance, insects, or insect resistance regarding the field.

20. The method of claim 16 further comprising queries regarding distribution and severity regarding condition of the crop in the field.

21. The method of claim 15 wherein the queries are related to observations of the field.

22. The method of claim 15 wherein the queries are related to opinions about the field or the crop in the field or factors related to the field or crop in the field.

23. The method of claim 15 further comprising storing the answers in a database.

24. The method of claim 15 further comprising communicating the answers to a website which can be accessed by authorized persons.

25. The method of claim 15 further comprising using the answers for at least one of:
a. integrating with answers from other fields;
b. making future decisions about the field; and
c. making decisions about the crop.

26. A system for gathering information about field crops comprising:
a. a portable digital device;
b. a geo-reference or position device in operative communication with the portable digital device;
c. software on the portable digital device including the following functions:
i. display of at least one pre-designed template comprising relevant or correlated queries regarding the field and the crop in the field, at least some of the queries including a checklist;
ii. data entry to allow input of answers to the queries;
iii. data storage of the answers; and
iv. display of selected information regarding the field or crop and/or information regarding other fields or crops.

27. The system of claim 26 wherein the pre-designed template comprises a plurality of sections, at least one section relating to customer and field identification, at least one section relating to condition of the crop in the field.

28. The system of claim 27 wherein the customer and field identification comprises information regarding one or more of:
a. person entering the answers;
b. customer name;
c. field location;
d. date and time; and
e. reason for visit to field.

29. The system of claim 27 wherein the condition of the crop in the field comprises information regarding one or more of:
a. herbicide injury;
b. nutrient issues;
c. weeds; and
d. weather.

30. The system of claim 27 further comprising another section related to disease, disease resistance, insects, or insect resistance regarding the field.

31. The system of claim 26 further comprising queries regarding distribution and severity regarding condition of the crop in the field.

32. The system of claim 26 wherein the queries are related to observations of the field.

33. The system of claim 26 wherein the queries are related to opinions about the field or the crop in the field or factors related to the field or crop in the field.

34. The system of claim 27 wherein at least some of the sections are color-coded.

35. The system of claim 26 wherein a template is pre-designed for different types of crops, but at least some sections of templates for different types of crops have similarities.

36. A method for data gathering related to a field service call by a field service agronomist comprising:
a. presenting to the field service agronomist
i. a predetermined systematic list of possible observations regarding
1. at least one crop and field condition;
ii. standardized rating questions for the at least one crop or field condition regarding its
1. distribution and
2. severity;
b. receiving, in digitally storable form, answers to the list of possible observations and the standardized rating questions from the field service agronomist;
c. correlating, in digitally storable form, the answers with
i. identifying information about the field, and
ii. geographic position of the field.

37. The method of claim 36 wherein the lists comprise descriptive information related to field service call observations.

38. The method of claim 36 wherein the list further comprises a list of predetermined suspected problems for fields or crop conditions.

39. The method of claim 37 further comprising standardized rating questions for the suspected problems.

40. The method of claim 38 wherein the standardizing rating questions relate to
a. distribution, and
b. severity.

41. The method of claim 36 wherein the checklists and rating questions are at least substantially consistent for a seed or crop type.

42. The method of claim 36 wherein the checklists and rating questions are at least substantially consistent for a seed or crop variety.

43. The method of claim 36 wherein the checklists and rating questions are at least substantially consistent for a plurality of seed or crop types or varieties.

44. The method of claim 36 further comprising storing the data in a database.

45. The method of claim 44 wherein the stored data comprises documentation useful for record keeping, research and development, planning, analysis, or legal documentation.

46. The method of claim 44 further comprising mining the database for information.

47. The method of claim 46 wherein the mining for information comprises information limited by
a. time; and/or
b. geographic position; and/or
c. weather or environment.

48. The method of claim 46 further comprising displaying or plotting the mined information.

49. The method of claim 48 wherein the displaying or plotting is based on mined information regarding one field or crop condition.

50. The method of claim 48 wherein the displaying or plotting is based on mined information regarding a plurality of field or crop conditions.

51. The method of claim 48 wherein the displaying or plotting is in the form of a map showing mined information relative to geographic position on the map.

52. The method of claim 46 further comprising communicating the mined information to one or more remote locations.

53. The method of claim 46 further comprising using the mined information for study at a location remote from the field.

54. The method of claim 46 further comprising using the mined information for collaboration with a plurality of people at remote location(s) from the field.

55. The method of claim 46 further comprising using the mined information to design research and development.

56. The method of claim 55 wherein the research and development relates to one or more of
a. trait analysis;
b. performance analysis;
c. diagnosis;
d. agronomic factors;
e. environmental classifications.

57. The method of claim 46 further comprising using the mined information to manage supply of seed.

58. The method of claim 57 wherein the step of managing supply of seed comprises:
a. coordinating growing and production of seed;
b. facilitating inventory of seed; or
c. timely supply of seed to growers.

59. The method of claim 46 further comprising using the mined information to plan marketing or track sales of seed.

60. The method of claim 36 wherein the field information comprises one or more of
a. field service representative identification;
b. type of or reason for field service call;
c. date;
d. time;
e. customer identification.

61. The method of claim 36 wherein field information comprises one or more of
a. information about the crop comprising one or more of
i. seed product name
ii. batch number
iii. planting date
iv. seeding depth
v. acreage; and
b. predetermined standardized lists regarding one or more of
i. previous planted crop
ii. growth stage of present crop
iii. irrigation
iv. tillage
v. plant part.

62. The method of claim 36 wherein crop and field conditions comprise one or more of
a. potential herbicide injury and possible reason
b. suspected nutrient issues
c. weather trends
d. agronomic seed factors.

63. The method of claim 62 wherein the weather trends are used to determine an environmental classification.

64. The method of claim 63 wherein the environmental classification is used to determine:
a. growing and production of seed varieties;
b. research and development of seed varieties;
c. remedial action at a field; and/or
d. supply of seed varieties.

65. The method of claim 36 wherein the rating questions on distribution comprise a list of
a. entire field
b. groups of plants
c. scattered plants
d. single plant.

66. The method of claim 36 wherein the rating questions for severity comprise a list of
a. low
b. medium
c. high.

67. The method of claim 38 wherein the list of suspected problems comprises
a. crop type
b. disease and part of plant
c. insects.

68. The method of claim 36 further comprising cues to the field service agronomist.

69. The method of claim 68 wherein the cue comprises a reminder for action.

70. The method of claim 36 further comprising collecting data from a plurality of fields, communicating the data from the plurality of fields to a central database, and making the central database available for access by authorized persons.

71. The method of claim 70 wherein the central database is used for tracking traits, crop progression, disease or insect progression, weather, and other trends over time.

72. The method of claim 70 wherein the central database is used to create environmental classifications.

73. An apparatus for efficient gathering, storage, communication and use of information regarding a field service call by a field service agronomist comprising:
a. a portable digital device including a display and a digital storage medium;
b. a mobile GPS receiver and software to produce geographic position data in digital format in operative communication with the portable digital device;
c. software operatively associated with the portable digital device adapted to
i. display a standardized, pre-designed template on the display, the template comprising
1. a predetermined systematic list of possible observations regarding
a. at least one crop and field condition;
2. standardized rating questions for the at least one crop or field condition regarding its
a. distribution and
b. severity;
ii. allow data input based on the template;
iii. create a database in the digital storage medium;
iv. marry the geographic position data, identifying information about the field, and observations and rating of the at least one crop or crop and field condition.

74. The apparatus of claim 73 wherein the portable digital device comprises a PDA, a pocket PC, a portable computer, or a tablet PC.

75. The apparatus of claim 73 wherein the software comprises a customizable data acquisition template software.

76. The apparatus of claim 73 further comprising an output adapted to communicate data to another device.

77. The apparatus of claim 76 wherein the other device comprises a computer, the internet, a website, a wide area network, a server, a local area network, or another portable digital device.

78. The apparatus of claim 73 further comprising an input for a peripheral device.

79. The apparatus of claim 78 wherein the peripheral device comprises a reader or a serial input port.

80. The apparatus of claim 79 wherein the reader comprises a barcode reader, an EMF reader, or an RF reader.

81. A method of updating field service call information in a central data base through a communications network in operative connection to a plurality of portable digital devices comprising:
a. compiling, on a digital device, field observations from a field service call;
b. operatively connecting the digital device to the communications network;
c. causing data related to the field observations to be communicated to the central data base.

82. The method of claim 81 wherein the communications network is a virtual private network (VPN) and further comprising requiring authentication of the digital device or its user before the step of causing data to be communicated.

83. A method of updating a web site server from a database containing field service call information from a plurality of field service calls comprising:
a. operatively connecting the database to the website server;
b. periodically sweeping data from the database to the web site server.

84. The method of claim 83 wherein the step of periodically is daily.

85. The method of claim 84 wherein the daily sweeping is at night.
